(19) United States
(12) Patent Application Publication
(10) Pub. No.: US 2013/0326466 A1
(43) Pub. Date: Dec. 5, 2013

(54) Human Readable Software Program Test Step

(71) Applicants: Yossi Rachelson, Petach Tikwa (IL); Ilan Meirman, Petach-Tikva (IL); Tal Abraham, Rehovot (IL); Amit Arbel, (US); Iris Sasson, (US)

(72) Inventors: Yossi Rachelson, Petach Tikwa (IL); Ilan Meirman, Petach-Tikva (IL); Tal Abraham, Rehovot (IL); Amit Arbel, (US); Iris Sasson, (US)

(21) Appl. No.: 13/483,120

(22) Filed: May 30, 2012

(51) Int. Cl. G06F 9/44

(52) U.S. Cl. 717/101

(57) ABSTRACT

Embodiments disclosed herein relate to a human readable software program test step. A processor may determine a human readable test step based on a user interaction with a user interface of a software program. The human readable test step may include a parameter to indicate where user input was provided to the user interface.

### BACKGROUND

A software program may be tested prior to releasing it to customers. For example, a test plan may consist of steps for interacting with the software program, and a tester may follow the test plan steps to test the software program. When following the test steps, the tester may identify defects in the software program. In some cases, a test plan may be created by a first person, and a second person may follow the test plan to test the software program.

### BRIEF DESCRIPTION OF THE DRAWINGS

The drawings describe example embodiments. The following detailed description references the drawings, wherein:

FIG. 1 is a block diagram illustrating one example of a computing system to create a human readable test plan for a software program.

FIG. 2 is a flow chart illustrating one example of a method to create a human readable test plan for a software program.

FIG. 3 is a diagram illustrating one example of an automatically generated test plan for a software program.

FIG. 4 is a diagram illustrating one example of an automatically generated test plan for a software program including a check point.

change test step instructions

### DETAILED DESCRIPTION

A test plan may be created with steps for testing the functionality of a software program. A human readable test plan for a software program plan may be automatically created based on a user interaction with a user interface generated by the software program, and the human readable test plan may be followed to test the software program. For example, a user may interact with the software program, and a processor may translate the user interaction into human readable test plan steps. A parameter may be shown in the test plan to indicate a point in the test plan where multiple variables may be tested. For example, a user may include a drop down box with multiple options for selection, and a processor creating the test plan based on the user interaction may include a step for making a selection in the drop down box to select a parameter where the default value is the one selected by the user during the creation of the human readable test plan. The parameter may indicate a point in the test plan where a tester may experiment with different input values to test the software program.

In one implementation, a test plan creator may create a check point within the test plan for checking the response of the user interface to a user input. For example, an item on the user interface may be marked as a check point during the creation of the human readable test plan such that the item's status or value in response to performing the test step is verified during recreation of a particular step in the test plan. The check point may be automatically or manually tested. For example, a human tester may verify the response of the software program to the test step, or a script or other software code may automatically compare the response of the software program to stored response information to determine if the software program responded to the test step as expected.

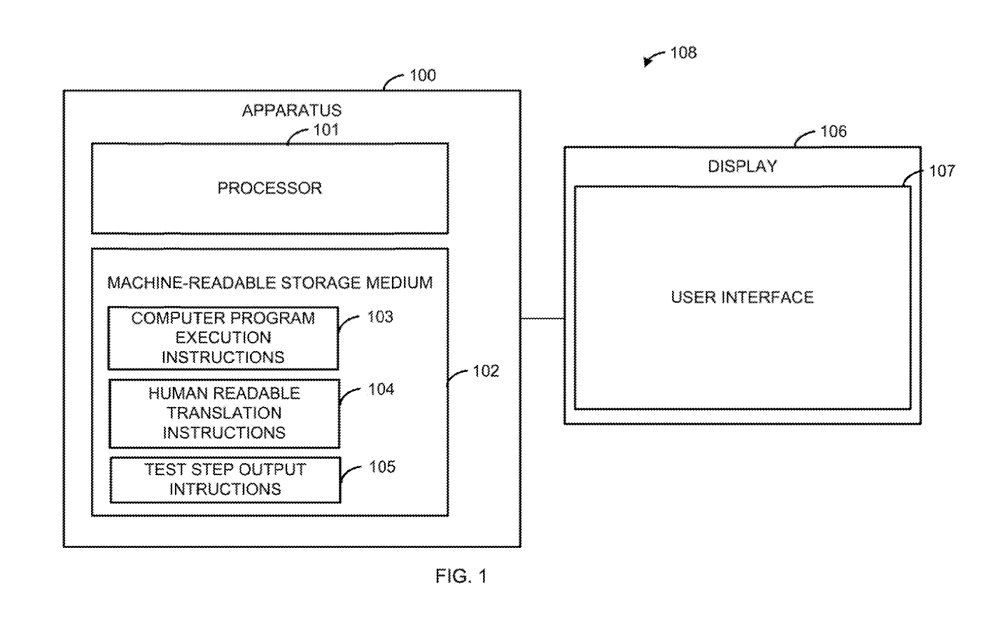

FIG. 1 is a block diagram illustrating one example of a computing system to create a human readable test plan for a software program. The computing system 108 may include, for example, an apparatus 100 communicating with a display 106. The apparatus 100 may be, for example, a desktop, laptop, server, or mobile computing device. The display 106 may be part of the apparatus 100, such as where the apparatus is a mobile computing device, or the display 106 may communicate with the apparatus 100 directly or via a network.

The display 106 may be, for example, a monitor. The display 106 may display a user interface 107 related to a software program. For example, the software program may be executed to create the user interface 107, and a test creator may interact with the user interface 107 to create a test plan for the software program. The user interface 107 may allow a user to provide user input to the user interface. As an example, the software program may be a document management system, and the user interface 107 may allow a user to input information to upload a document and to perform a search to retrieve a stored document.

The apparatus 100 may include a processor 101 and a machine-readable storage medium 102. The processor 101 may be any suitable processor, such as a central processing unit (CPU), a semiconductor-based microprocessor, or any other device suitable for retrieval and execution of instructions. In one embodiment, the apparatus 100 includes logic instead of or in addition to the processor 101. As an alternative or in addition to fetching, decoding, and executing instructions, the processor 101 may include one or more integrated circuits (ICs) or other electronic circuits that comprise a plurality of electronic components for performing the functionality described below. In one implementation, the apparatus 100 includes multiple processors. For example, one processor may perform some functionality and another processor may perform other functionality.

The machine-readable storage medium 102 may be any suitable machine readable medium, such as an electronic, magnetic, or other physical storage device that stores executable instructions or other data (e.g., a hard disk drive, random access memory, flash memory, etc.). The machine-readable storage medium 102 may be, for example, a computer readable non-transitory medium.

The machine-readable storage medium may include software program execution instructions 103, human readable test step translation instructions 104, and test output instructions 105. Software program execution instructions 103 may include instructions for executing a software program. For example, the software program execution instructions 103 may be an executable version of the software program that may be executed to run the software program. The processor 101 may execute the software program, and the software program may include instructions for displaying the user interface 107 on the display 106.

The human readable translation test step instructions 104 may include instructions to automatically create test steps for the software program based on a user's interaction with the user interface 107 generated based on the software program. A user may interact with the user interface 107, and the user's interactions may be translated into human readable test steps. For example, a user may enter a password into the user interface 107, and the processor may evaluate the user interaction to create the test step “Enter a password”.

Information provided to the user interaction during the test creation may be automatically marked as a parameter in the test plan. For example, the processor 101 may determine that a user selected a particular radio button on the user interface 107, and the processor may create a test step to select a radio button where the particular radio button selected during the test creation is marked as a parameter value in the test step. In some cases, the tester receiving the test plan may include different inputs in place of the parameter. In one implementation, a parameter is included in the test step, and a default value of the parameter is associated with the test step. The default value may be, for example, the value provided during the test step creation. The default value may provide a sample value to the tester following the steps recited in the test plan.

The test output instructions 105 may include instructions to output a test plan. The test plan may include human readable steps for testing the software program. The test plan may provide human readable instructions related to the test steps allowing the test plan to be replicated by a human tester. The test plan may be output, for example, by displaying, storing, or transmitting it. The test plan may be accessed by a tester to replicate the steps in the test plan. For example, the tester may retrieve the test plan from a storage or receive it via a network. In one implementation, the test plan steps are displayed to allow user confirmation of the automatically created steps. For example, the user creating the test plan may edit or remove one of the displayed test steps.

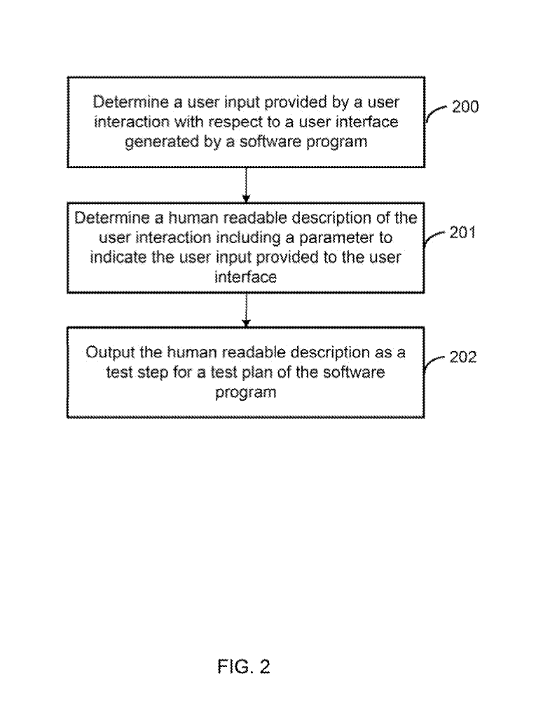

FIG. 2 is a flow chart illustrating one example of a method to create a human readable test plan for a software program. For example, a processor may automatically create a human readable test plan for a software program based on a user interaction with a user interface generated by the software program. The human readable test plan may include parameters representing data input during the creation of the test plan. For example, the user interaction with the user interface may involve providing data to the user interface, and a parameter may be included in the step to indicate a variable where the data was provided. In some implementations, the data actually provided may also be included with the test step. The processor may determine whether a user interaction should be included in the test step as a parameter. For example, the processor may determine that information provided in the form of a selection of an item on the user interface is a test step without a parameter, and information typed in the user interface is a parameter for a test step for entering information in the particular area of the user interface. The method may be implemented, for example, by the apparatus 100 in FIG. 1.

Beginning at 200, a processor determines a user input provided by a user interaction with respect to a user interface generated by a software program. The software program may be any suitable type of software program, such as a standalone application or a client server application. The software program may be a web application. The software program may be written in any suitable programming language, such as Java or C++. The method may be tailored to a particular language or may be the same for each language. The processor creating the test plan, or a second processor, may execute the software program. Executing the software program may generate a user interface. For example, the user interface may allow a user to provide user input and receive information related to the functionality of the software program.

The user interaction may be any suitable interaction with the user interface, such as a mouse movement, gesture, or touch selection, or information spoken relative to the user interface. The user interaction may be determined any suitable manner. The user interaction may be determined based on information from a peripheral device, such as from a keyboard or mouse. The user interaction may be determined based on information from a sensor, such as from a camera or microphone.

The processor may determine a user input provided to the user interface by the user interaction. The user input may be determined based on a change to the user interface, such as where an item on the user interface is moved in response to a user mouse movement. The user interaction may represent, for example, moving, selecting, or deleting an item on the user interface or inputting information. The input may involve selecting an item on the user interface or providing a free form input, such as drawing a circle with a stylus or typing a word in a textbox. For example, a user touch to a particular area of a display may indicate a selection of an icon in that area of the display or the selection of a radio button on a web interface. In one implementation, a change to the user interface is detected, such as the movement of a cursor or an input typed.

Moving to 201, the processor determines a human readable description of the user interaction including a parameter to indicate the user input provided to the user interface. The human readable description may be determined in any suitable manner. The processor may compare the user interaction information to database information about translations. In one implementation, the processor has access to the code executing, and identifies items in the user interface based on names provided to the items within the code. In one implementation, the step is translated based on naming conventions in the software program, and the steps are compared to a database of test steps language to create a higher level language version of the test step. The processor may combine multiple interactions with the user interface into a single test step. For example, the step may include putting a cursor in a password text box and entering a text, but the step may be output as “enter the password.”

The parameter may be used to indicate that a tester using the test plan may select a value to test. A parameter may be included for an input or a subset of inputs provided to the user interface. For example, an input to select a tab may be translated into a human readable step without a parameter for the particular tab selected, and an input to type information into a text box may be translated into a human readable step with the text entered as a parameter. In one implementation, the types of inputs to be included as parameters may be updated, such as based on a user preference. For example, a test creator may indicate the types of user interactions to associate with parameters.

In one implementation, the provided input is provided as a default value for the parameter. For example, the provided input may be included within the human readable description to provide a sample value for the parameter variable. The processor may determine whether to include the default value based on settings information. In some cases, a default value may be provided for a first type of input but not for a second type of input.

Proceeding to 202, the processor outputs the human readable description as a test step for a test plan of the software program. For example, a test plan may include multiple steps for a user to perform relative to a user interface created by a software program. The test step may be added to the test plan. The test step may be stored with the test plan or transmitted to another device to be added to the test plan. In some implementations, the test step may be displayed to the user. A test step may be added to a test plan individually or a group of test steps may be grouped as a test plan. The test plan may be used by a tester to test the software program. The test plan may be stored such that a tester may access the test plan. For example, the test plan may be retrieved directly or via a network. In one implementation the human readable description may be displayed, such as on a display associated with the electronic device performing the test. In some implementations, the test plan may be saved, and a user may later access it. A user may verify the performed steps are added to the test plan.

In one implementation, the processor displays the human readable description such that the human readable description may be edited. The test plan may be displayed on a user interface that allows a user to add an additional step to the test plan manually. In one implementation, the user interface allows a user to edit a test step automatically added to the test plan. For example, a user may create part of the test plan automatically and part of the test manually. A user may view the automatically created test step and add additional information that may be useful to a tester recreating the test step.

The user interface may allow a parameter in a test step to be manually edited. For example, a parameter may be changed from a variable value to a test step with a particular value. In some cases, a test step with a particular value may be changed to a parameter variable value. The default value of the parameter may be updated or a default value of the parameter may be manually provided. For example, a, range of values for the parameter may be added to the test plan. In one implementation, test data may be associated with a parameter in a test step. For example, a file or database of test data may be associated with a particular parameter in the. test step. A tester receiving the test plan may use the test data in place of the parameter when testing the software program. The processor may store the updated test plan with the manual edits such that the updated test plan may be retrieved for testing the software program.

In one implementation, the test plan may include information in addition to the listed test steps. For example, a test plan may include additional items or attachments. In one implementation, a user may capture a screen shot of the user interface and associate it with the test plan. A second tester using the test plan may view the screen shot to determine, for example, that the test is conducted properly or that the system responds properly. The screen shot may be annotated to provide specific information about the test or expected response.

The test plan may include a recording of the user interaction with the user interface. For example, a user may select to begin a recording or a recording may automatically be created when a test plan is created based on the user interaction. The recording may be, for example, a video filed associated with the test plan. The video may show the changes in the user interface as a user provides input to the user interface. The video may indicate to a tester more detail about how to provide input according to the test step instructions. In some cases, a tester may have access to the human translated test steps and the video.

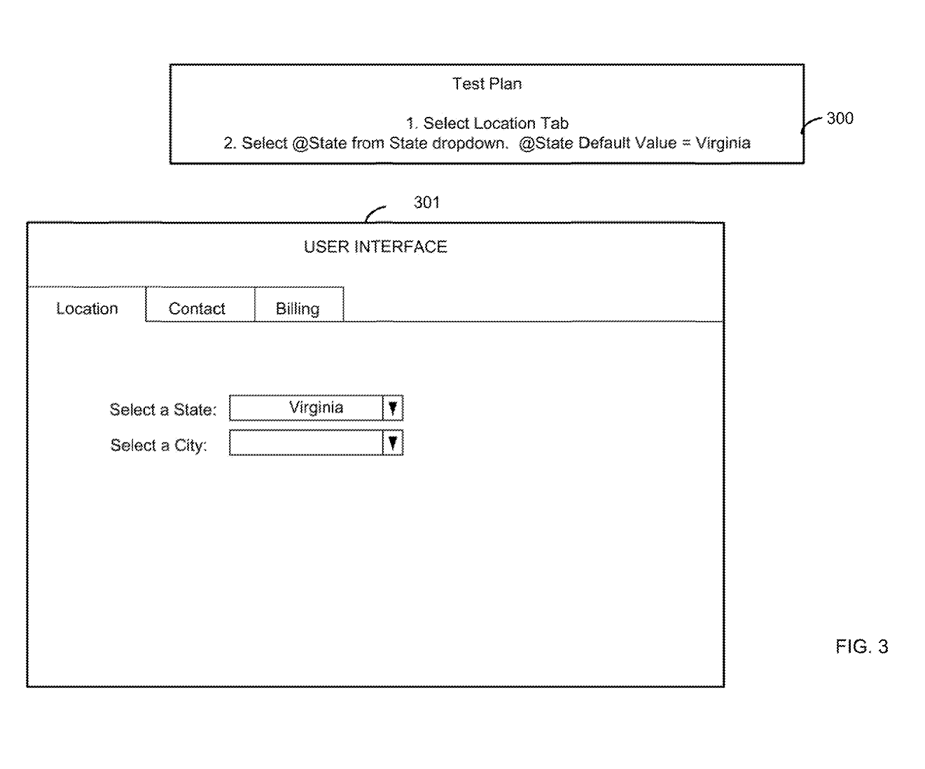

FIG. 3 is a diagram illustrating one example of an automatically generated test plan for a software program. The software program may be executed, and the user interface 301 may be displayed. A user may interact with the user interface 301, and the test plan 300 related to the user's interactions may be created.

The user interface 301 includes three tabs. The user interface 301 shows the location tab selected. The location tab includes a drop down for a state selection, and a drop down for a city selection. The user interface 301 shows “Virginia” selected from the state drop down box.

The test plan 300 may automatically be created to describe the tester's actions with respect to the user interface 301. For example, a step to select the location tab may be generated as the user selects the location tab. The step may include selecting the location tab as a step. A second step to select a state from the State dropdown may be generated as the user selects “Virginia” from the State dropdown.

The test plan 300 may include parameters indicating variable data in the test plan where a tester may select different types of data. For example, the tester may follow the test plan multiple times while using different data as the parameter data each time. In one implementation, the data may be automatically described as a parameter with a default value as the value entered by the test creator and the test creator may edit the test plan to mark the default value as the test value such that the parameter is not included. For example, the test may be a test to determine the response to selecting a particular state on the user interface 301. In one implementation, the test creator may edit the test plan to include other pieces of sample data to associated with the parameter.

The test plan 300 includes a first step to select the location tab and a second step to select a state parameter within the State dropdown with a default value of “Virginia”. A tester replicating the test plan 300 may select the location tab and select either the state of “Virginia” from the state dropdown or a different state from the state dropdown. A second test may include a step for selecting a tab where the particular tab selected is included as a parameter value such that a test may select a different tab.

In one implementation, a user interface for creating a test plan may include a manner for a user to indicate a check point in the test plan. The check point may be a point within the test where the functionality of the user interface in response to a user action is confirmed. The check point may, for example, be a point where a user manually checks the response of the user interface or where the processor for testing the software program automatically checks the response of the user interface when a particular value is provided to the user interface. In some cases, the check point may be associated with a parameter in the test step, and the response of the user interface may be checked based on different parameter values provided to the user interface.

A user may indicate a check point while interacting with the user interface to create the test plan. For example, the user may select an item on the user interface and then select a check point button. The check point button may be used to indicate that a change to the user face in response to the user interaction is to be included in the test plan. The user may indicate a particular field to be checked. For example, a user may select a radio button and mark a text box as a check point to indicate that the text box should be checked in connection with the selection of the radio button. In one implementation, a test plan creator may add multiple check points to a test plan, and a user may associate a name or other identifier with each of the check points.

Information about the check point may be included in the test plan. For example, the processor may translate the user's interaction with the user interface into a set of steps, and the processor may add information about the check point to the list of steps. A user recreating the test step, may confirm that the information associated with the check point in the test plan occurs in connection with the performance of the test step.

In one implementation, the check point information is automatically confirmed during recreation of the test step. For example, a user may press a button or otherwise provide input to the testing user interface for the user interface response to be checked. In one implementation, a test script is associated with the user interface to perform automatic checking of the check points while a user manually tests the user interface by following the test steps in the test plan.

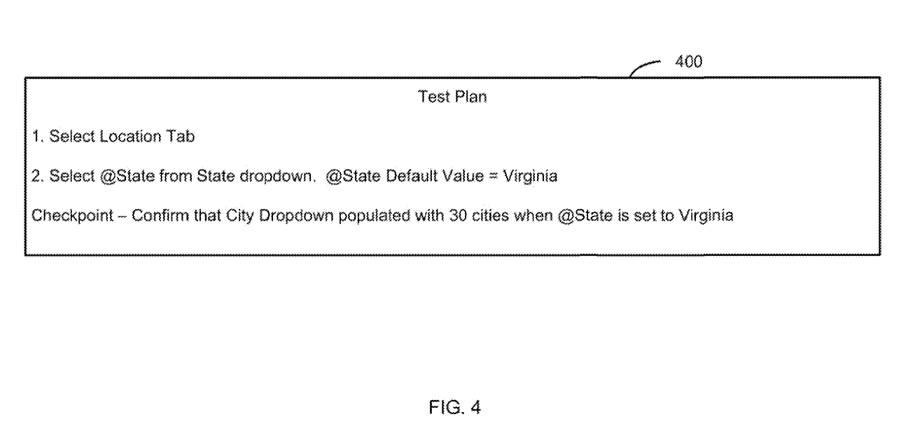

FIG. 4 is a diagram illustrating one example of an automatically generated test plan for a software program including a check point. The test plan 400 includes two steps. The first step includes a step to select a location tab and the second step includes a test step to select a parameter from a dropdown where the default value is “Virginia”. The second step includes a check point to confirm that the city dropdown on the user interface is populated with 30 cities when the state parameter is set to “Virginia”. The check point may manually or automatically confirm the response of the user interface during the recreation of the test step.

1. An apparatus, comprising:
a machine-readable non-transitory storage medium comprising instructions to:
execute a software program to generate a user interface on a display;
determine a human readable test step for a test plan of the software program from a user interaction with the user interface, wherein the human readable test step includes a parameter to indicate where the user provided a value to the user interface;
output the test step; and
a processor to execute the instructions stored in the machine-readable non-transitory storage medium.

2. The apparatus of claim 1, wherein the machine-readable non-transitory storage medium further comprises instructions to generate a user interface to:
display the test step; and
receive user input to add a step to a test plan including the test step.

3. The apparatus of claim 1, wherein the machine-readable non-transitory storage medium further comprises instructions to:
create a recording of the user interaction with the user interface; and
associate the recording with the test plan.

4. The apparatus of claim 1, wherein the machine-readable non-transitory storage medium further comprises instructions to:
capture a screen shot of the user interface;
generate a user interface to allow user input to annotate the screen shot; and
associate the annotated screen shot with the test plan.

5. The apparatus of claim 1, wherein the instructions to include a parameter comprise instructions to include a parameter with a default value as the value provided to the user interface.

6. The apparatus of claim 1, further comprising instructions to associate a check point with the parameter, wherein the check point indicates a response by the user interface associated with the parameter.

7. A method, comprising:
determining, by a processor, a user input provided by a user interaction with respect to a user interface generated by a software program;
determining, by a processor, a human readable description of the user interaction including a parameter to indicate the user input provided to the user interface; and
outputting, by a processor, the human readable description as a test step for a test plan of the software program.

8. The method of claim 7, further comprising outputting a sample value of the parameter with the test step as the value provided to the user interface.

9. The method of claim 7, further comprising:
recording the user interaction; and
associating the recording with the test plan.

10. The method of claim 11, further comprising adding a check point to the test step to indicate a change to the user interface in response to the user interaction.

11. The method of claim 7, wherein determining a human readable description of the user interaction comprises:
comparing user interaction information to stored test step language; and
outputting the stored test step language.

12. A machine-readable non-transitory storage medium comprising instructions executable by a processor to:
execute a software program to display a user interface on a display device;
translate a user interaction with the user interface into a human readable description,
wherein a parameter is included within the human readable description to indicate where determined the user interaction includes providing information to the user interface; and
add the human readable description to a test plan associated with the software program.

13. The machine-readable non-transitory storage medium of claim of 12, further comprising instructions to associate the information provided to the user interface as a default value for the parameter.

14. The machine-readable non-transitory storage medium claim of 12, further comprising instructions to:
capture a screen shot of the user interface; and
associate the screen shot with the test plan.

15. The machine-readable non-transitory storage medium of claim 12, further comprising instructions to store information related to a change in the user interface associated with the user interaction of the test step.
